(19) United States
(12) Patent Application Publication
(10) Pub. No.: US 2026/0329330 A1
(43) Pub. Date: Oct. 22, 2026

(54) SCALABLE SYMMETRIC ARCHITECTURE FOR FREE SPACE OPTICAL VECTOR-MATRIX MULTIPLICATION

(71) Applicant: Neurophos Inc., Austin, TX (US)

(72) Inventors: Bradley Jay Sissom, Boulder, CO (US); Hold Finkelstein, Albany, CA (US); Andrew J. Traverso, Durham, NC (US)

(73) Assignee: Neurophos Inc., Austin, TX (US)

(21) Appl. No.: 19/653,012

(22) Filed: Apr. 20, 2026

Related U.S. Application Data
(60) Provisional application No. 63/791,872, filed on Apr. 21, 2025.

(51) Int. Cl. G06E 1/04

(52) U.S. Cl. CPC G06E 1/045

(57) ABSTRACT

The techniques described herein relate to an apparatus and method for computing general linear operations using a symmetric free space architecture configured for block-wise optical signal summation. An example system encodes input vectors into vector-encoded optical signals using a two-dimensional (2D) transmitter array. The vector-encoded optical signals are transmitted by the 2D transmitter array across a first free space optical path and then received by a spatial light modulator (SLM). The SLM is configured to modulate the vector-encoded optical signal in accordance with matrix entries of a weight matrix to generate SLM output, including a plurality of modulated optical signals. A second free space optical path performs a block-wise summation of the plurality of modulated optical signals of the SLM output to generate a summation output. The summation output is received by photodetectors of a 2D receiver array configured to generate an output vector based on the summation output.

### RELATED APPLICATIONS

This patent claims priority under 35 U.S.C. § 119(e) to U.S. Provisional Application No. 63/791,872, titled “SCALABLE SYMMETRIC ARCHITECTURE FOR FREE SPACE OPTICAL MATRIX-VECTOR MULTIPLICATION,” filed Apr. 21, 2025, which is hereby incorporated by reference in its entirety.

### FIELD

The techniques described herein relate generally to optical computing and, more particularly, to a scalable symmetric architecture for free space optical vector-matrix multiplication.

### BACKGROUND

Optical computing and photonics use light instead of electricity to process information, offering substantial improvements in speed and energy efficiency. Photonic integrated circuits include optical components onto a single chip, allowing data to be processed at the speed of light with minimal heat. Such technology is advantageous for heavy mathematical workloads, such as those computed by machine learning models (e.g., neural networks), as such photonic integrated circuits can perform complex matrix multiplications simultaneously across multiple wavelengths.

### SUMMARY

In accordance with the disclosed subject matter, systems, methods, apparatus, and articles of manufacture are provided for computing general linear operations using a symmetric free-space optical architecture configured for block-wise optical signal summation.

Some embodiments relate to a system for performing optical vector-matrix multiplication. The system includes a two-dimensional (2D) transmitter array including a plurality of optical modulators. The 2D transmitter array is configured to encode entries of an input vector into a vector-encoded optical signal and emit the vector-encoded optical signal. The system includes a spatial light modulator (SLM) including a plurality of programmable pixels arranged into frames, each frame corresponding to a row of a weight matrix, wherein the SLM is configured to modulate the vector-encoded optical signal in accordance with matrix entries of the weight matrix to generate SLM output, the SLM output including a plurality of optical signals that is output from the frames. The system includes a first free space optical path positioned between the 2D transmitter array and the SLM. The system includes a second free space optical path configured to perform a block-wise summation of the plurality of optical signals of the SLM output to generate a summation output. The system includes a 2D receiver array including a plurality of optical detectors configured to generate an output vector based on the summation output, wherein the second free space optical path is between the SLM and the 2D receiver array.

Some embodiments relate to a method for performing optical vector-matrix multiplication. The method includes encoding, by using a two-dimensional (2D) transmitter array, entries of an input vector into encoded optical signals. The method includes projecting, by using the 2D transmitter array and a first free space optical path, the encoded optical signals onto a spatial light modulator (SLM). The method includes modulating, by using the SLM, the encoded optical signals at a plurality of frames of the SLM according to corresponding row entries of a weight matrix to generate modulated signals, each frame of the SLM corresponding to a portion of the weight matrix. The method includes imaging, by using a second free space optical path, the modulated signals onto a 2D receiver array, wherein the second free space optical path is configured to perform block-wise summation of the modulated signals to generate a summation output. The method includes detecting, by using a 2D receiver array, the summation output to generate output vector values.

Some embodiments relate to an optical computing apparatus. The optical computing apparatus includes a photonic integrated circuit including a plurality of waveguides and modulators configured to encode an input vector. The optical computing apparatus includes free space optics. The free space optics include a two-dimensional (2D) transmitter array including a plurality of optical modulators. The 2D transmitter array is configured to encode, by using at least one of intensity modulation, amplitude modulation, or phase modulation, entries of an input vector into a vector-encoded optical signal. The 2D transmitter array is configured to emit the vector-encoded optical signal. The free space optics include a spatial light modulator (SLM) including a plurality of programmable pixels arranged into frames, each frame corresponding to a row of a weight matrix, wherein the SLM is configured to modulate the vector-encoded optical signal in accordance with matrix entries of the weight matrix to generate an SLM output, the SLM output including a plurality of optical signals that is output from the frames. The free space optics include a first free space optical path positioned between the 2D transmitter array and the SLM. The free space optics include a second free space optical path configured to perform a block-wise summation of the plurality of optical signals of the SLM output to generate a summation output. The free space optics include a 2D receiver array including a plurality of optical detectors configured to generate an output vector based on the summation output. The optical computing apparatus includes an electronic integrated circuit configured to drive the modulators on the photonic integrated circuit and to decode output values from the 2D receiver array, wherein the second free space optical path is between the SLM and the 2D receiver array.

### BRIEF DESCRIPTION OF DRAWINGS

Various aspects and embodiments of the present technology will be described with reference to the following figures. It should be appreciated that the figures are not necessarily drawn to scale. Items appearing in multiple figures are indicated by the same or a similar reference number in all the figures in which they appear.

FIG. 1 illustrates alternate perspectives of an ideal layered network associated with a conventional free space optical architecture and its corresponding ray traces, in accordance with some embodiments of the technology described herein.

FIG. 2 illustrates a matrix decomposition of the one-dimensional (1D) free space optical architectures shown in FIG. 1 and the correspondence of the matrix decomposition with a layered network, in accordance with some embodiments of the technology described herein.

FIG. 3A illustrates a matrix decomposition and block transformation in an example Scalable Symmetric Architecture, in accordance with some embodiments of the technology described herein.

FIG. 3B illustrates matrix summation in the Scalable Symmetric Architecture of FIG. 3A, in accordance with some embodiments of the technology described herein.

FIG. 4A illustrates an example implementation of the Scalable Symmetric Architecture of FIGS. 3A and 3B, in accordance with some embodiments of the technology described herein.

FIG. 4B illustrates alternate perspectives of the matrix decomposition performed in the Scalable Symmetric Architecture of FIG. 4A, in accordance with some embodiments of the technology described herein.

FIG. 4C illustrates a ray tracing diagram of the Scalable Symmetric Architecture of FIG. 4A, in accordance with some embodiments of the technology described herein.

FIG. 5 illustrates another example implementation of the Scalable Symmetric Architecture of FIGS. 3A and 3B, in accordance with some embodiments of the technology described herein.

FIG. 6 illustrates a block diagram of an example optical vector-matrix multiplication (OVMM) device, in accordance with some embodiments of the technology described herein.

FIG. 7 is a flowchart representative of an example process that may be performed and/or implemented using hardware logic or machine-readable instructions that may be executed by processor circuitry to implement the Scalable Symmetric Architecture of FIGS. 3A and 3B and/or the OVMM device of FIG. 6, in accordance with some embodiments of the technology described herein.

FIG. 8 is an example electronic platform including the OVMM device of FIG. 6 and structured to effectuate the process of FIG. 7, in accordance with some embodiments of the technology described herein.

### DETAILED DESCRIPTION OF INVENTION

The present disclosure provides techniques for achieving improvements in the technology of computing general linear operations by using optical signaling. The techniques involve modulating coherent, incoherent, or partially coherent light to generate a plurality of samples of a signal to which a linear operation is to be applied. These samples can be duplicated to a plurality of spatial light modulator elements. These spatial light modulator elements can be configured to alter an amplitude and/or a phase of the duplicated signal samples. The signals after being modulated can be recombined with the sample fields either coherently superimposed or incoherently summed to determine the result of the computed linear operation. The signals can be recombined using free space optics.

Vector-matrix multiplication (VMM) (also referred to as matrix-vector multiplication) is a fundamental operation in artificial neural networks and other computational systems. The inventors have recognized that optical implementations of VMM offer the potential for high-throughput, low-latency computation by exploiting the inherent parallelism of free space optical signal propagation.

The conventional approach to optical vector-matrix multiplication (OVMM), known as the Goodman (or Stanford) vector-matrix multiplier architecture, requires anamorphic or astigmatic optical systems with cylindrical lenses to perform different operations in orthogonal directions. An anamorphic lens is an optical element that applies different magnifications or focal powers along two orthogonal axes, producing asymmetric imaging or beam shaping in the horizontal and vertical directions independently. However, it has been recognized within the context of the present disclosure that such anamorphic systems are challenging to design, fabricate, and test.

However, it has been recognized within the context of the present disclosure that the miniaturization of optical computing systems is of importance to the advancement of next-generation computation. Continued scaling of electronic processors is increasingly constrained by fundamental limits in interconnect bandwidth, transistor density, and thermal dissipation. Free space optical computing offers an approach to high-throughput vector-matrix multiplication (VMM), but realizing these advantages in practice requires optical computing architectures reducible to compact, integrated form factors compatible with the size, weight, and power constraints of modern computing platforms.

It has been recognized within the context of the present disclosure that conventional Goodman-based free space optical computing architectures hinder miniaturization by requiring multi-element refractive lens trains (including cylindrical and anamorphic elements) to satisfy paraxial linearity constraints across the full spatial extent of the transmitter and receiver arrays. Consequently, as channel count, numerical aperture, and field size increase, progressively more optical elements must be added. Increasing the number of optical elements consumes available air space and yields optical trains whose physical length, element count, and alignment sensitivity are incompatible with compact, integrated form factors.

It has also been recognized within the context of the present disclosure that the use of one-dimensional (1D) transmitter (TX) and receiver (RX) arrays in Goodman-type architectures further compounds the miniaturization challenge by concentrating all input and output channels along a single spatial axis, while leaving the orthogonal spatial dimension of the optical channel unutilized. Such 1D computing leads to an inefficiency that drives up physical size and optical complexity per unit of computational throughput.

Embodiments disclosed herein include an optical VMM architecture that overcome the aforementioned technological shortcomings of conventional Goodman-type architecture. The OVMM described herein, and referred to as a Scalable Symmetric Architecture, performs VMM on two-dimensional (2D) TX and RX array configurations that more fully exploit the available spatial bandwidth of the optical channel.

Adventitiously, OVMM architectures described herein mitigate the requirement for anamorphic optics by using a block matrix decomposition and microlenslet array integrator with rotationally symmetric imaging optics. Some such OVMM architectures use a microlenslet array at the metasurface plane to define block boundaries, and a telecentric Fourier-transform lens to image modulated block signals onto a two-dimensional (2D) receive (RX) array. Same-index pixels from all blocks are overlaid on each RX detector to perform optical summation.

Embodiments disclosed herein involve an optical VMM architecture that computes general linear operations using optical signaling. These general linear operations may be used to compute a vector-matrix multiplication, for example those used in the implementation of machine learning models. An example machine learning model is an artificial neural network. Examples of an artificial neural network include a convolutional neural network (CNN), a recurrent neural network (RNN), and long short-term memory (LSTM) networks.

The optical VMM architecture disclosed herein includes a spatial light modulator (SLM). The SLM may be implemented by at least one metasurface, A collection of individual SLM modulators may be grouped, the group denoted as an “SLM frame,” so that the modulation applied by each modulator in the group corresponds to the value of an element in a single row of the matrix to be multiplied. The matrix can be a weight matrix. The element-wise multiplication of the input vector and the single row may be implemented by modulating each transmit mode as relayed to the SLM by the corresponding SLM modulator with the result in the respective scattered modes of the SLM modulators.

As a first benefit, the example OVMM architecture disclosed herein leverages information theory from conventional 2D optical imaging systems to achieve balanced optical system performance tradeoffs. For example, established information theory informs signal to noise ratio (SNR) based trades such as pixel size versus channel capacity.

Second, the OVMM architecture disclosed herein enables direct imaging of individual metasurface blocks onto the 2D RX array. Beneficially, the direct imaging facilitates self-diagnostics, calibration, and phase retrieval of optical signals. Buffer areas between metasurface blocks can also be configured to serve as local phase references for differential phase determination at the 2D RX array.

Third, the OVMM architecture disclosed herein can be configured to employ multi-scale lenses to overcome inherent tradeoffs that arise in conventional lens designs (e.g., field-of-view vs. focal length). The OVMM architecture disclosed herein can be configured to achieve improved wavefront error by splitting the front end into scaled arrays of micro-optics that each operate on smaller areas of the field. Combined scaling effects may improve system wavefront error. The 3D OVMM architecture can be arranged in smaller and simpler configurations when employing a multiscale lens design in contrast to corresponding larger and more complex conventional lens architectures.

Fourth, multiscale lenses included in the disclosed OVMM architecture can be rotational in nature and thereby be fabricated and measured with less complex techniques.

Fifth, the disclosed OVMM architecture achieves inherently better optical efficiency (e.g., link loss) than astigmatic Goodman-type architectures. Astigmatic architectures may simultaneously present a one-dimensional (1D) image and orthogonal 1D Fourier transform at the image detection surface. In various embodiments described herein, energy belonging to an orthogonal Fourier transform spreads to either side of the image detector and is not collected.

Sixth, in some embodiments, the disclosed OVMM architecture employs a metasurface to perform the matrix mask function to allow modulation of the intensity, amplitude, and/or phase of optical signals. The metasurface can be configured to operate as an adaptive optical component to compensate for wavefront error across the RX array.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

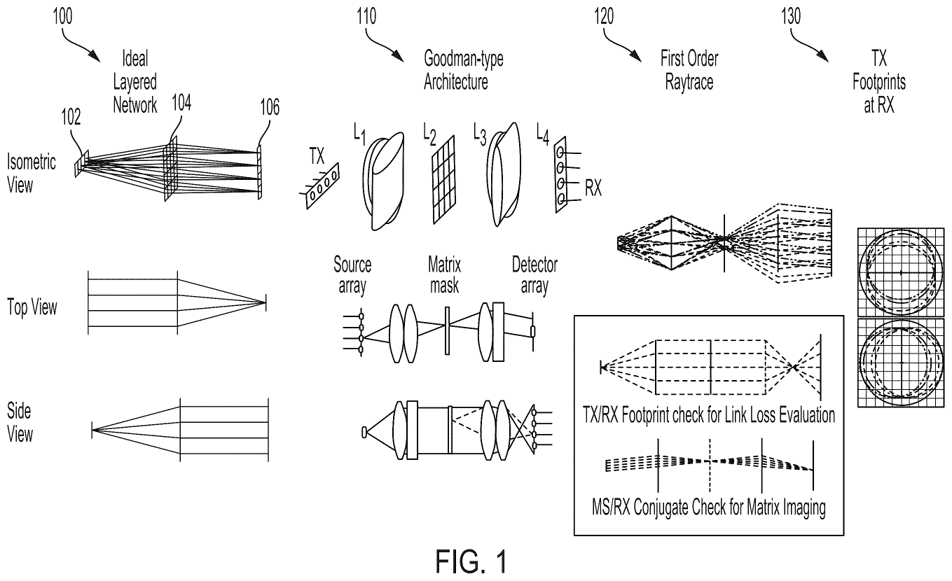

FIG. 1 illustrates alternate perspectives of an ideal layered network 100 associated with a Goodman-type (or Stanford-type) free space optical computing architecture 110 and its corresponding ray traces 120. The transmitter (TX) footprints 130 at the receiver (RX) array of the optical architecture 110 is also shown.

The layered network 100 shows a simplified schematic of matrix operations in the optical architecture 110. As described further below, data encoded into an input vector 102 undergo matrix operations in a matrix 104. Applying matrix operations produces a resultant vector 106.

The Goodman-type architecture 110 performs vector-matrix multiplication using light propagating through a series of optical elements arranged along a common optical axis. The Goodman-type architecture 110 is configured to perform the matrix operations in the left-most column of FIG. 1. The Goodman-type architecture 110 is a widely used architecture in conventional optical signal processing and referred to as astigmatic (or anamorphic) due to its ability to perform operations in different directions.

At the leftmost position is a TX array, depicted as a structured planar array M of TX elements (e.g., light-emitting diodes (LEDs) or laser diodes). Each element in the source array encodes a component of the input vector 102, with an intensity or amplitude of emitted light representing the corresponding scalar value. TX elements are each driven with analog amplitude corresponding to the input vector values. As shown, the TX elements individually address N respective columns of the input vector 102.

Light emitted by the TX elements is collected by a first converging lens L₁ (e.g., first Fourier lens). L₁ maps each point source in the TX array to a corresponding plane wave propagating at a distinct angle, such that the Fourier transform of the source distribution is formed at the rear focal plane of L₁. This ensures that an intensity distribution from each source element uniformly and independently illuminates a mask plane of the matrix mask.

L₂ is a second converging lens (e.g., second Fourier lens), positioned such that its front focal plane coincides with the rear focal plane of L₁. L₂ performs a second Fourier transform, reimaging the source array distribution onto the plane of the matrix mask. This ensures that each source element in the TX array is mapped to a spatially distinct and well-defined region of the matrix mask, enabling independent row-by-row weighting of the input vector components.

Located at the output plane of the L₁-L₂ is the matrix mask, depicted as a rectangular grid of M×N transmissive cells functioning as a spatial light modulator (SLM). Each cell encodes a weight value of the computational matrix, modulating the amplitude of the incident light in proportion to the corresponding matrix element. The 2D spatial arrangement of mask cells maps directly to the rows and columns of the matrix, enabling simultaneous parallel weighting of all input channels across the full matrix in a single optical pass.

Following the matrix mask is L₃, the third converging lens. L₃ performs a Fourier transform on the spatially modulated light exiting the mask, converting the weighted spatial distribution into an angular spectrum. This Fourier transform optically integrates the contributions from all source elements that share a same matrix column.

The fourth lens L₄ performs a final Fourier transform, focusing and mapping each integrated output channel onto a spatially distinct location on the RX array, including N rows of RX elements. L₄ ensures that each detector element receives light corresponding to exactly one output of the vector-matrix product. The resulting amplitude, detected at each RX element, contains the vector-matrix multiplication result after analog values are decoded.

Ray trace simulations 120 are used to confirm that the Goodman-type architecture 110 establishes requisite Fourier-plane conjugate relationships between the TX array, matrix mask, and RX detector array. Footprint analysis 130 at each lens (e.g., L₁, L₂, L₃, and L₄) aperture is used to verify that ray bundles, as shown in the ray trace simulations 120, from all TX channels are captured within clear apertures of the lenses throughout the optical path. Light directed outside of the lens clear aperture is lost, resulting in link loss variation.

Goodman-type processors only produce accurate vector-matrix multiplication (VMM) results when the refractive optics behave as a linear system governed by Snell's Law, which for diffractive and interferometric implementations is generally considered a reasonable approximation only when ray angles are less than approximately 6 to 10 degrees from the optical axis. This paraxial constraint fundamentally limits the angular extent over which the 1D TX source array and 1D RX detector array can be reliably addressed, restricting the spatial bandwidth and channel count of the system.

Satisfying the linearity requirement of a Goodman-type architecture across the full spatial extent of the 1D TX and RX arrays typically necessitates lens designs composed of many refractive elements, as additional elements redistribute optical power across individual surfaces to reduce angles of incidence at each interface. In miniature or integrated implementations, this multi-element approach rapidly consumes all available air space between elements, imposing severe constraints on system miniaturization and integration density.

Strategies employed to linearize Goodman-type optical systems fundamentally break down for architectures with large numerical apertures (NA) and/or large fields of view, precisely the conditions required to scale the 1D TX and RX arrays to large channel counts. As the number of input and output channels grows, the demands on NA and field size increase correspondingly, such that no practical multi-element refractive lens design can simultaneously satisfy the linearity, miniaturization, and channel-count requirements of a high-capacity Goodman-type optical computing system.

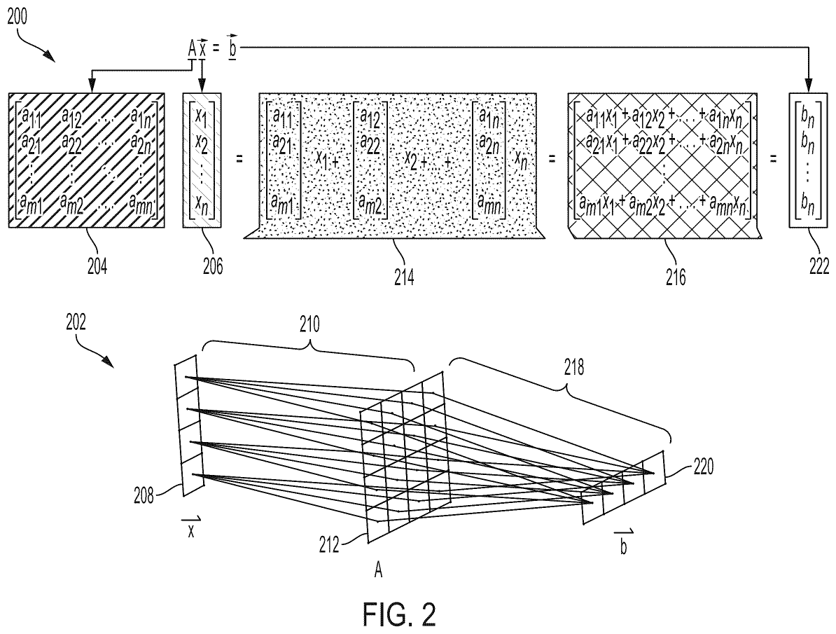

FIG. 2 illustrates a matrix decomposition 200 of 1D free space optical architectures, such as the Goodman-type architecture 110 described in connection with FIG. 1 and the correspondence of the matrix decomposition with a layered network 202.

In the illustrated example, the architecture 110 is computing the mathematical equivalent of A\vec{x} =\vec{b}, where A is a matrix 204 of, for example, weightings to be applied via multiplication to an input vector, \vec{x}, 206. A resultant vector, \vec{b}, 208 is the product of the vector-matrix multiplication.

The input vector 206 is encoded into a vector-encoded optical signal 208 via one or more components. The vector-encoded optical signal 208 may include modulated optical radiation corresponding to the input vector 206.

As shown, the vector-encoded optical signal 208 is expanded via an optical fan-out operation 210 performed by an optical system (not shown). The optical fan-out operation 210 spreads the vector-encoded optical signal 208 along a first axis (e.g., in one dimension) onto a two-dimensional modulation matrix mask 212 as shown. The optical fanout operation 210 includes an outer product expansion 214 of the product of A\vec{x}.

The vector-encoded optical signal 208 interacts with the optical modulation parameters on the matrix mask 212. As the vector-encoded optical signal 208 passes through and/or is reflected by the matrix mask 212, the optical radiation is modulated pixel-by-pixel to produce a modulated optical signal that represents the unsummed results of vector-matrix multiplication 216. Effectively, the matrix mask 212 performs the element-wise multiplication of the vector elements with the matrix parameters.

The optical system performs a condensing operation 218 on the modulated optical signal. The condensing operation 218 condenses the modulated optical signal along the first axis, effectively summing the contributions of each element to form a condensed optical signal 220. The condensed optical signal 220 corresponds to the final resultant vector, \vec{b}, 222 of the vector-multiplication, A\vec{x}×=\vec{b}. The condensed optical signal 220 may be decoded into electronic signals for further processing or use.

Conventional matrix decomposition, such as the matrix decomposition described in FIG. 2, is performed with optical systems that require cylindrical and/or anamorphic lenses. Anamorphic lenses often suffer from optical aberrations and are highly sensitive to alignment at the consequence of link loss. Additional optical elements may be included to compensate for the limitations of anamorphic lenses. However, such solutions further increase lens element count, exacerbates the multi-element complexity and air-space consumption, and compounds the field scaling failures of the optical system. Thus, such configurations make it impractical to simultaneously satisfy the linearity, miniaturization, and channel-density requirements of a high-capacity optical computing architecture.

Further, the use of 1D TX arrays and 1D RX arrays in Goodman-type optical computing architectures inherently underutilizes an additional dimension available in the optical channel. Consequently, all input and output channels are distributed along a single axis and thereby concentrates ray angles into a narrow linear field. Such configurations simultaneously demand large NA to maintain channel density and accelerates the multi-element lens complexity and field scaling failures that fundamentally limit the throughput and miniaturization of the system.

The techniques described herein relate to a Scalable Symmetric Architecture, which is configured to avoid the scale-limitations that negatively affect the aforementioned Goodman-architecture. As detailed further below, the Scalable Symmetric Architecture is configured to perform matrix operations without the need for anamorphic lenses. Instead of using a lens system to collimate light, such as the first lens Li of the optical architecture 110 described in connection with FIG. 1, the optical signals are allowed to spread before interacting with the SLM.

Additionally, the Scalable Symmetric Architecture uses 2D TX arrays and 2D RX arrays, which overcomes additional scale-limitations of the Goodman-type architectures. Due to the system's symmetric design, the 2D TX array, the SLM, and the 2D RX array may be configured and aligned to preserve wavefront coherence (e.g., phase coherence) between transmitted, modulated, and received optical signals, as described further herein.

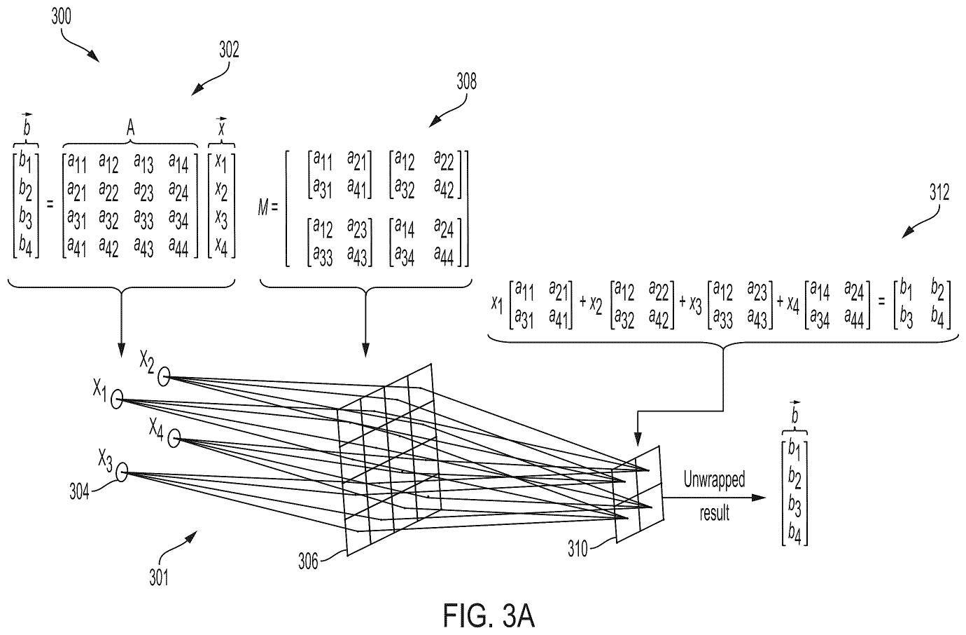

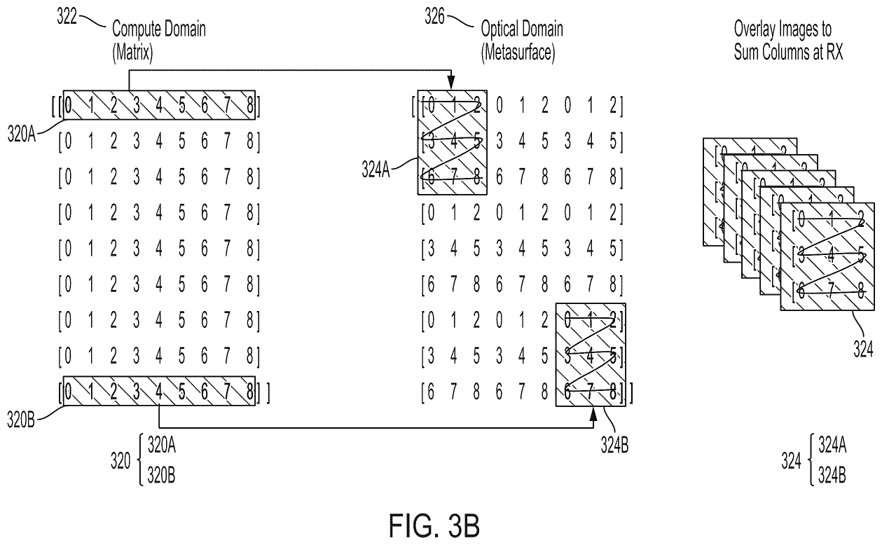

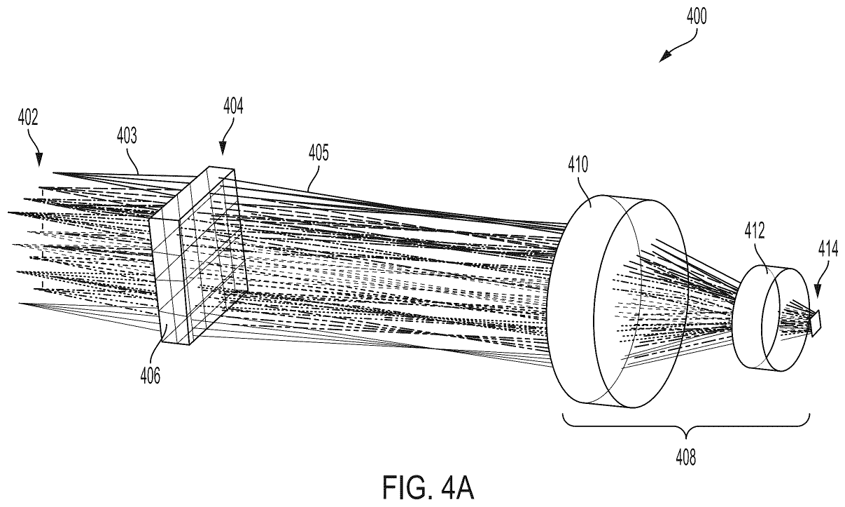

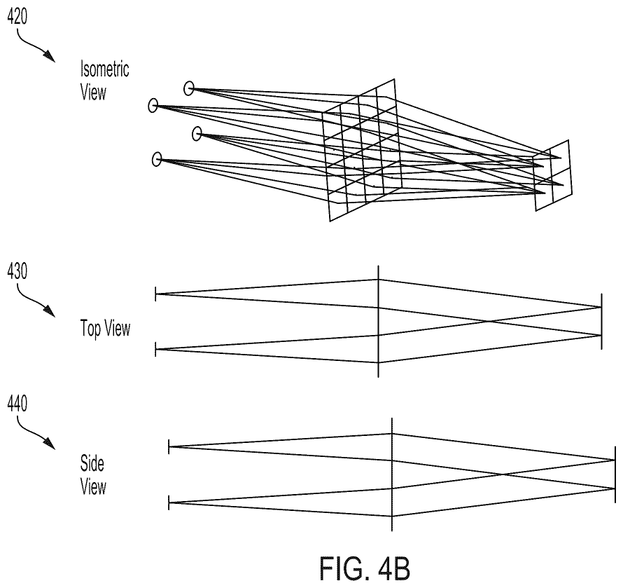

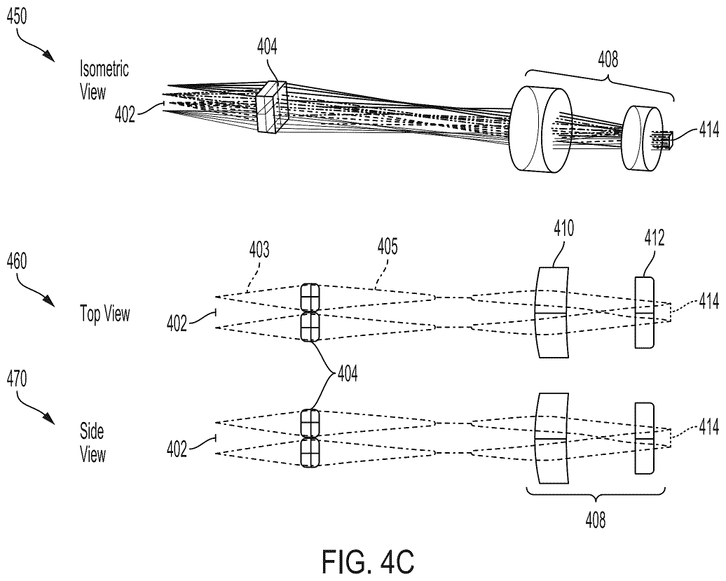

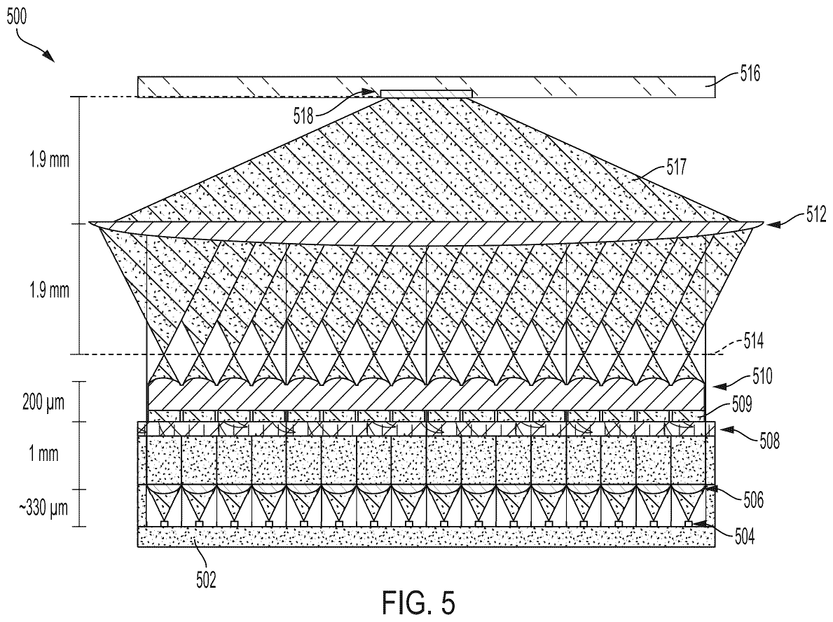

FIG. 3A illustrates a matrix decomposition 300 and block transformation 301 in a Scalable Symmetric Architecture. The matrix decomposition 300 shown may also be implemented by example implementations of the example Scalable Symmetric Architectures 400, 500 as detailed below in connection with FIGS. 4A-4C and/or FIG. 5.

In the illustrated example, the matrix decomposition 300 starts with a first matrix 302, which is the mathematical equivalent of A\vec{x}=\vec{b} where A is a matrix of, for example, weightings to be applied via multiplication to an input vector, \vec{x}, much like the matrix decomposition depicted in FIG. 2. A resultant vector, \vec{b}, is the product of the vector-matrix multiplication. While in FIG. 3A the vector-matrix multiplication is illustrated as rows and columns, embodiments are not limited to implementations that physically arrange the elements in rows and columns as shown.

The input vector is encoded into a vector-encoded optical signal into a 2D TX array 304 via one or more components. Examples of the components include a digital-to-analog converter, an amplifier, and one or more optical radiation transmitters of a silicon photonic transmitter system. The vector-encoded optical signal may be encoded based on one or more of an intensity, amplitude, or phase of the optical signals.

The 2D TX array 304 transmits the vector encoded optical signals onto a spatial light modulator (SLM) 306. An example of the SLM 306 is a metasurface. The SLM 306 of this example contains encoded values that correspond to a second matrix 308. The second matrix 308 includes column vectors associated with the input vector of the first matrix 302.

The vector-encoded optical signals interact with the optical modulation parameters on the SLM 306. As the vector-encoded optical signal passes through and/or is reflected by the SLM 306, the optical radiation is modulated pixel-by-pixel to produce a modulated optical signal that represents the unsummed results of vector-matrix multiplication. Effectively, the matrix mask performs the element-wise multiplication of the vector elements with the matrix parameters.

The modulated optical signals are then projected onto a 2D RX array 310. All columns are subsequently wrapped into square blocks to create an equivalent matrix decomposition 312 pending unwrapping the results into column vectors. Unwrapping the equivalent matrix decomposition 312 may be performed by using an Electronic Integrated Circuit (EIC) coupled to the Scalable Symmetric Architecture by generating drive signals.

FIG. 3B illustrates matrix summation in the matrix decomposition operation at the 2D RX array 310 of FIG. 3A.

As shown, the 2D TX array 304 has encoded an input vector with 9 entries 320 by a 9×9 compute domain matrix 322. The entries 320 and resulting compute domain matrix 322 are associated with encoded optical signals at the 2D TX array 304. For example, a first encoded optical signal encoded by the 2D TX array 304 may correspond to a first entry 320A in the compute domain matrix 322.

In some embodiments, scalar values of the entries 320 of the compute domain matrix 322 may include an amplitude and/or phase of associated optical signals. In other embodiments, the scalar values of the entries 320 may include an intensity of the associated optical signals. In yet other embodiments, the scalar values of the entries 320 may include amplitude, phase, and intensity of associated optical signals.

When received by the SLM 306, entries 320 of the compute domain matrix 322 may be arranged as a 3×3 block 324 of TX elements within an optical domain matrix 326. As shown, the blocks 324 of the optical domain matrix 326 are arranged as 3×3 groups of 3×3 pixel blocks, such that each row in the compute domain matrix 322 is mapped into a 3×3 block. For example, the first entry 320A in the compute domain matrix 322 corresponds to a first block 324A in an upper left block of the optical domain matrix 326. As another example, a second entry 320B of the compute domain matrix 322 corresponds to a second block 324B in a lower right block of the optical domain matrix 326.

To perform matrix multiplication, the TX array 304 illuminates a 3×3 block 324 of the optical domain matrix 326. The reflected light from all blocks 324 is then projected onto a 3×3 array of RX array 310, such that the first elements of all blocks 324 are overlaid on the first RX array 310, and so on.

In various embodiments, every separate block of the SLM 306 is conjugate to the 2D RX array 310, wherein the 2D RX array 310 is of dimensions N×N. N×N images of the blocks may be aligned and stacked by a Fourier transform (FT) lens. In various embodiments, the TX footprints at the 2D RX array 310 are rectangular and the size of one block. Beneficially, this configuration makes the incident energy (e.g., from the encoded optical signal) identical in size to the 2D RX array 310. In various embodiments, link losses become a function of the 2D RX array 310 fill factor only. Overfill of the 2D RX array 310 by larger TX footprints may be eliminated with this architecture.

Without loss of generality, TX and RX elements (e.g., gratings) may be square, circular, or rectangular. The TX and RX elements may have a side (e.g., for square or rectangular elements) or diameter (e.g., for circular elements) of 5 micrometers (μm), 10 μm, 12 μm, 15 μm, 25 μm, 50 μm, 75 μm, or 100 μm.

Further, though the example shown in FIGS. 3A-3B are of N×N dimensions, this configuration is not limiting. In other embodiments, the TX elements, SLM elements, and RX elements may be of M×N dimensions, wherein M and/or N can be 2, 4, 8, 16, 32, 64, 256, 1024, or 2048.

FIG. 4A illustrates an example Scalable Symmetric Architecture 400 configured to implement the matrix decomposition 300 illustrated in FIGS. 3A-3B. FIG. 4B illustrates alternate perspectives 420, 430, 440 of the matrix decomposition performed in the Scalable Symmetric Architecture 400 of FIG. 4A. The alternate perspectives 420, 430, 440 include an isometric view perspective 420, a top view perspective 430, and a side view perspective 440.

FIG. 4C illustrates a ray tracing diagram of the Scalable Symmetric Architecture 400 of FIG. 4A. FIG. 4C illustrates alternate perspectives 450, 460, 470 of Scalable Symmetric Architecture 400 of FIG. 4A. The alternate perspectives 450, 460, 470 include an isometric view perspective 450, a top view perspective 460, and a side view perspective 470. The top view perspective 460 and side view perspective 470 illustrate the optical signals 403, emitted by the TX array 402, transmitting through the SLM 404 to generate the SLM output 405 before subsequently transmitting through the telecentric FT lens 408 to be received by the RX array 414.

As shown, the Scalable Symmetric Architecture 400 includes a 2D TX array 402 emitting optical signals. The TX array 402 may include a number of TX elements configured in an N×N TX element array. The TX array 402 may emit optical signals 403 (e.g., encoded optical signals) including encoded data from an input vector, as described for \vec{x} in connection with FIG. 3A. In some embodiments, the 2D TX array 402 is implemented by at least one chip (not shown) (e.g., a silicon photonics chip) with grating couplers or edge emitters.

The encoded optical signals 403 are received by a spatial light modulator (SLM) 404. The SLM 404 may include a plurality of programmable pixels arranged into frames 406, each frame of the frames 406 may correspond to a row of a weight matrix (e.g., A of FIG. 3B). The SLM 404 may be configured to generate SLM output 405. The SLM output 405 may include a plurality of optical signals that is output from ones of the frames. For example, the SLM output 405 can include a light beam that is output from each of the frames 406.

The described scheme can be utilized with a reflective SLM or with a transmissive SLM. For example, when the SLM is a reflective SLM, the SLM may be configured to reflect and modulate the vector-encoded optical signal such that the second free space optical path is configured to direct the vector-encoded optical signal toward a reflective surface of the SLM and to collect the modulated SLM output from the reflective surface.

The SLM 404 may be implemented with materials whose reflectivity or transmissivity and/or phase retardation may be controlled, for example by using an electronic signal. In some embodiments, the SLM 404 may be implemented as an active metasurface with liquid crystal. In other embodiments, the SLM 404 may be implemented with an active metasurface with electrochromic molecules.

In some embodiments, the Scalable Symmetric Architecture 400 may utilize other transmissive SLMs. For example, if information is encoded using intensity (e.g., with a coherent, partially coherent, or incoherent light source), an array of EAMs may be utilized instead of a metasurface. In some such embodiments, the TX array 402 can encode the optical signals 403 using intensity and the SLM 404 can be replaced with an array of EAM pixels, wherein the EAM modulates the intensity of the optical signals 403. In various embodiments, the EAM pixels may alternatively, additionally, or partially be implemented using thin-film modulators (e.g., lithium-niobate or barium-titanate modulators). In some embodiments, the EAM pixels may be co-packaged on waveguides disposed in the TX array 402.

The plurality of programmable pixels making up the SLM 404 may be a plurality of individually addressable pixels. In some embodiments, the individually addressable pixels of the SLM 404 may be configured to modulate characteristics of incident light. For example, when light emitted by the TX array 402 is at least partially coherent light, the SLM 404 may be configured to modulate at least one of an amplitude or a phase of the output from the TX array 402. In such an embodiment, the SLM 404 may modulate the at least one of the amplitude or the phase in accordance with matrix entries of the weight matrix to generate the SLM output 405.

In some embodiments, the light emitted by the TX array 402 is incoherent. In such embodiments, vector-encoded optical signals may be encoded in the TX array 402 using intensity values. The SLM 404 in such embodiments may be configured to modulate an intensity, amplitude, and/or phase of the output from the TX array 402.

As shown, the Scalable Symmetric Architecture 400 includes a telecentric FT lens 408. The telecentric FT lens 408 of this example includes a first lens 410 and a second lens 412, both aligned on an optical axis along the Scalable Symmetric Architecture 400. The telecentric FT lens 408 is positioned between the SLM 404 and a 2D RX array 414. The first lens 410 is closer to the SLM 404 while the second lens 412 is closer to the RX array 414. In other embodiments, the telecentric FT lens 408 includes only one lens. In yet other embodiments, the telecentric FT lens 408 includes more than two lenses.

In some embodiments, the Scalable Symmetric Architecture 400 may include an additional telecentric FT lens (not shown) between the TX array 402 and the SLM 404. For example, another instance of the telecentric FT lens 408 can be disposed between the TX array 402 and the SLM 404. In other embodiments, the Scalable Symmetric Architecture 400 may include a single instance of the telecentric FT lens 408, with the single instance being between the TX array 402 and the SLM 404.

The RX array 414 is configured to receive and subsequently decode the SLM output 405. The decoding may be performed by using an EIC configured to perform the decoding as described in connection with FIGS. 3A-3B.

The FT telecentric lens 408 is configured to be insensitive to axial displacement of the TX array 402 and RX array 414. Such a property improves vector-matrix multiplication by spatially illuminating the RX array 414 precisely. Each RX detector element in the RX array 414 may receive an equally well-registered, distortion-free projection of a corresponding optical signal from the SLM 404. The implementation of at least one telecentric FT lens 408 may beneficially suppress inter-channel crosstalk, minimize parallax-induced magnification errors, and ensure that optical power is delivered to each RX detector at an approximately normal angle of incidence, thereby maximizing RX array 414 quantum efficiency and signal-to-noise ratio across all channels of the optical computing system.

FIG. 5 illustrates another example Scalable Symmetric Architecture 500 configured to implement the matrix decomposition 300 illustrated in FIGS. 3A-3B.

The Scalable Symmetric Architecture 500 of this example includes a 2D TX array 502 that includes a plurality of optical modulators. The two-dimensional transmitter array is configured to encode entries of an input vector (e.g., \vec{x} of FIG. 3A) into a vector-encoded optical signal and subsequently emit the vector-encoded optical signal.

The 2D TX array 502 may include a plurality of waveguides to propagate the vector encoded optical signal out of the 2D TX array. The waveguides may be single-mode strips or ridge waveguides. Waveguides may have, for example, a width of between 200 nm and 800 nm with a height between 150 nm and 300 nm.

In some embodiments, the 2D TX array 502 includes an electronic integrated circuit (EIC) (e.g., complementary metal-oxide-semiconductor (CMOS) EIC) (not shown). The vector-encoded optical signals may be encoded by using the EIC. The EIC may generate driving signals to drive the optical modulators (e.g., intensity, amplitude, and/or phase modulators). The optical modulators may include electro-absorptive modulators (EAMs), Mach-Zehnder interferometers, optical ring resonators, silicon-insulator-silicon-capacitive (SISCAP) modulators, or thermal modulators. The optical modulators may be coupled to the waveguides in the 2D TX array 502, such that input vector entries are encoded in intensity, amplitude, and/or phase. The plurality of optical modulators and the plurality of waveguides may be driven by the EIC via at least one bump bond (e.g., copper bumps) or at least one through-silicon via (TSV).

The 2D TX array 502 may include a photonic integrated circuit (PIC) (not shown) that forms the 2D TX array 502. The PIC can be electrically coupled to the EIC and optically coupled to a light source (not shown). The EIC may include processor circuitry configured to drive the modulators on the PIC.

In some other embodiments, the Scalable Symmetric Architecture 500 is driven monolithically without use of an EIC. For example, the PIC may include the 2D TX array and drive circuitry monolithically integrated therein, wherein the drive circuitry is configured to drive the plurality of optical modulators.

The 2D TX array 502 receives light from the light source. In some embodiments, the light source is a coherent light source or a partially coherent light source. The 2D TX array 502 may be configured to encode the entries of the input vector into the vector-encoded optical signal by using at least one of an amplitude modulation, a phase modulation, or an intensity modulation. In other embodiments, the 2D TX array 502 can be configured to encode the entries of the input vector into the vector-encoded optical signal using only intensity modulation.

In some embodiments, the light source is an incoherent light source. In such embodiments, the 2D TX array 502 can be configured to encode the entries of the input vector into the vector-encoded optical signal using only intensity modulation. In some embodiments, each channel may individually have a long coherence length (e.g., be individually coherent) while being mutually incoherent with all other channels. For example, the 2D TX array 502 may include a bank of independent single-mode laser sources, such that a single independent laser source (e.g., a light emitting diode (LED), a microLED, a vertical-cavity surface-emitting laser (VCSEL), or a fiber optic cable) supplies a single TX element. In some embodiments, each laser source is mutually incoherent with all other laser sources. In some embodiments, the 2D TX array 502 is configured to generate and modulate light simultaneously.

In some embodiments, the 2D TX array 502 includes a plurality of laser diodes 504 (e.g., edge emitting diode lasers or vertical-cavity surface-emitting lasers (VCSELs)) configured to generate the vector-encoded optical signals using driving signals provided by the EIC. The plurality of laser diodes may be configured to generate laser beams with wavelengths in the near infrared (NIR) (e.g., approximately 750 to 1400 nanometers (nm)) and/or shortwave infrared (SWIR) (e.g., approximately 1400 to 1600 nm) regions. In some embodiments, the laser diodes may be configured to generate laser beams with wavelengths in the visible (e.g., 400 to 750 nm) range. The plurality of laser diodes may be configured to operate at a speed of approximately 10 to 112 gigabits per second (Gbps). The plurality of laser diodes may be configured to achieve a maximum power during operation of approximately 3 milli Watts (mW) to 200 mW, including any value in that range.

In some embodiments, the 2D TX array 502 includes a plurality of fiber optic cables, configured like the plurality of laser diodes as described above.

As shown, the Scalable Symmetric Architecture 500 includes a first microlens array 506, positioned between the 2D TX array 502 and an SLM 508. The first microlens array 506 includes a first plurality of microlenses and each microlens of the first plurality of microlenses is configured to receive a beam (e.g., laser beam) emitted from the 2D TX array 502. The first microlens array 506 is configured to output the respective beams to the SLM 508.

As shown, the first microlens array 506 is separated from the 2D TX array 502 by a distance of approximately 330 μm. In other embodiments, the first microlens array 506 may be separated from the 2D TX array 502 by a distance in a range from 25 μm to 500 μm.

As shown, the first microlens array 506 is separated from the SLM 508 by a distance of approximately 1 millimeter (mm). In other embodiments, the first microlens array 506 is separated from the SLM 508 by a distance in a range from 50 μm to 5 mm.

The SLM 508 may include a plurality of programmable pixels arranged into frames, each frame corresponding to a row of a weight matrix (e.g., A of FIG. 3A). The SLM 508 may be configured to modulate the vector-encoded optical signal in accordance with matrix entries of the weight matrix to generate an SLM output 509, the SLM output 509 consisting of a plurality of optical signals that is output from the frames. In some embodiments, the frames of the SLM are arranged as a periodic 2D tiled array across an SLM aperture. In some embodiments, the SLM 508 may be configured like the SLM 404 as described in connection with FIG. 4A.

In some embodiments, the SLM 508 is made of a programmable active metasurface. The programmable active metasurface may include a plurality of individually addressable pixels, each of the plurality of individually addressable pixels configured to modulate at least one of an amplitude or a phase of incident light. The programmable active metasurface may be configured to modulate the at least one of the amplitude or the phase of incident light by using a liquid crystal mixture made of one or more liquid crystals.

In some embodiments, the SLM includes buffer regions disposed between adjacent frames. The buffer regions may be configured to transmit or reflect a reference optical signal. Beneficially, the non-reflective properties of the buffer regions may minimize optical cross-talk between separate pixels of the SLM 508 at the 2D RX array 516. In some embodiments, the 2D RX array 516 may be configured to receive the reference optical signal from the buffer regions to enable differential phase calibration of the system.

As shown, the Scalable Symmetric Architecture 500 includes a second microlens array 510 positioned between the SLM 508 and a lens 512. The second microlens array 510 includes a second plurality of microlenses. Each microlens of the second plurality of microlenses is configured to receive a beam exiting the SLM 508. The second microlens array 510 may be configured to focus the SLM output 509 onto a focal plane 514 before fanning out the respective beams to the at least one first lens 512. As shown, the focal plane 514 and the lens 512 are separated by a distance of approximately 1.9 mm. In other embodiments, the focal plane 514 and the lens 512 are separated by a distance in a range from 0.1 mm to 5 mm.

In some embodiments, the lens 512 is configured to perform a spatial Fourier transform on the SLM output 509 to generate a Fourier-transformed SLM output 517. The Fourier-transformed SLM output 517 may include a summation of the plurality of optical signals.

The lens 512 is configured to focus the Fourier-transformed SLM output 517 on a 2D RX array 516. The 2D RX array 516 includes a plurality of optical detectors 518 configured to generate an output vector based on the Fourier-transformed SLM output 517. The 2D RX array 516 may be configured like the RX array 414 described in connection with FIG. 4A. As shown, the lens 512 and the 2D RX array 516 are separated by a distance of approximately 1.9 mm. In other embodiments, the lens 512 and the 2D RX array 516 are separated by a distance in a range from 0.1 mm to 5 mm.

The lens 512 may be a telecentric lens. For example, the lens 512 may be configured like the telecentric FT lens 408 of FIG. 4A. For example, the lens 512 may include two lenses to achieve telecentricity. In some embodiments, a second lens (not shown) is configured to image output from each frame of the SLM 508 onto a corresponding single optical detector of the 2D RX array 516.

The Scalable Symmetric Architecture 500 includes a first free space optical path connecting the 2D TX array 502 and the first microlens array 506. The Scalable Symmetric Architecture 500 also includes a second free space optical path, which connects the SLM 508 and the 2D RX array 516. The second free space optical path includes the second microlens array 510, the lens 512, and the focal plane 514 which is formed by the second microlens array 510.

The Scalable Symmetric Architecture 500 may be configured with geometric path-length symmetry or conjugate-plane symmetry with respect to the first free space optical path and the second free space optical path. For example, the first free space optical path and the second free space optical path may be configured such that the 2D TX array and the 2D RX array are each optically conjugate to the SLM. As another example, a free space optical path, including the first free space optical path and the second free space optical path, may include rotationally symmetric optics. In some embodiments, the Scalable Symmetric Architecture 500 is configured to preserve wavefront coherence (e.g., phase coherence) between transmitted, modulated, and received optical signals.

In some embodiments, a spatial filter (not shown) is disposed in the second free space optical path between the SLM and the 2D RX array. The spatial filter may be configured to transmit optical signals directed at respective optical detectors of the 2D RX array and/or to attenuate optical signals not directed at the respective optical detectors of the 2D RX array. The spatial filter may include an aperture. In some embodiments, the aperture is a spatial filter aperture. In some embodiments, the spatial filter may be a metal diaphragm with a hole drilled in it. For example, the aperture can be a hole drilled in the metal diaphragm.

In some embodiments, the spatial filter is a spatial filter element implemented by a patterned transparent plate that is opaque except for the area for which radiation is permitted to pass. The aperture may be the area for which radiation is permitted to pass. In some embodiments, the pattern on the transparent plate may be a graded transmission profile, like a Gaussian profile, rather than, by way of example, a circular pattern which is maximum transmission inside the circle and minimum transmission outside the circle.

The EIC may be configured to decode the Fourier-transformed SLM output 517 to generate the output vector. In some embodiments, the EIC includes a vision processing unit configured to execute at least one post-detection operation on the output values from the 2D RX array 516. In some embodiments, the at least one post-detection operation includes an accumulation, Rectified Linear Unit (ReLU) activation, and/or normalization operation. In such embodiments, the vision processing unit is configured to execute at least one of the accumulation, the ReLU activation, or normalization operation.

In various embodiments, the 2D TX array 502 includes a first two-dimensional array of grating couplers, each grating coupler optically coupled to a corresponding waveguide modulator on the PIC. In such embodiments, the 2D RX array 516 includes a second two-dimensional array of grating couplers, each optically coupled to one or more corresponding optical detectors via optical waveguides on the PIC. In some embodiments, adjacent grating couplers are separated by a pitch sufficient to provide optical isolation between channels such that stray light incident on the 2D RX array outside an acceptance cone of a given grating coupler does not couple into the optical waveguide associated with that grating coupler. In some embodiments, the pitch may be in a range of 50 μm to 5 mm.

In some embodiments, the 2D RX array includes a low-reflectivity absorbing material disposed between adjacent grating couplers. The absorbing material may be configured to attenuate stray optical signals not directed at any grating coupler. For example, the absorbing material may be at least one of a carbon black, graphite, titanium nitride, black chrome, iron oxide, carbon nanotube composite, or photo-absorbing material. In some embodiments, the absorbing material is a metasurface engineered to not reflect (e.g., block or absorb) light within a predefined wavelength range.

In other embodiments, the 2D TX array 502 includes a first two-dimensional array of emitting couplers, each emitting coupler optically coupled to a corresponding waveguide modulator on the PIC. In such embodiments, the 2D RX array 516 includes a second two-dimensional array of emitting couplers, each optically coupled to one or more corresponding optical detectors via optical waveguides on the PIC.

In some embodiments, the plurality of optical modulators, the frames, and the plurality of optical detectors are each spatially arranged in a square array or a rectangular array. In other embodiments, the plurality of optical modulators, the frames, and the plurality of optical detectors are spatially arranged in a geometric shape different from a square array or a rectangular array. For example, the plurality of optical modulators, the frames, and the plurality of optical detectors may be spatially arranged in a geometric shape different from a square array or a rectangular array. Such a geometric shape can be a triangle, a quadrilateral (e.g., a parallelogram, a rhombus, a trapezoid, a kite), a polygon (e.g., a pentagon, a hexagon, a heptagon, an octagon, a nonagon, a decagon), a circle, an ellipse, an oval, a semicircle, or a star shape (e.g., a pentagram or other n-pointed star).

In some embodiments, a number of the plurality of optical modulators in the 2D TX array 502, a number of frames of the SLM 508, and a number of the plurality of optical detectors in the 2D RX array 516 are all equal. Alternatively, the number of the plurality of optical modulators in the 2D TX array 502, the number of frames of the SLM 508, and the number of the plurality of optical detectors in the 2D RX array 516 may be different, such as each being of M×N dimensions.

The Scalable Symmetric Architecture 500 includes a number of channels, wherein each channel corresponds to an independent optical path linking a single TX source element of the 2D TX array 502, through a frame of the SLM 508, and to a single RX element of the 2D RX array 516. The total number of channels determines the dimension of the input vector and the number of rows of the weight matrix that can be processed in a single parallel optical pass. The number of channels may include, but not be limited to, 10, 16, 64, 128, 256, 1024, or 4000 channels.

In some embodiments, the matrix decomposition 300 of FIGS. 3A-3B may be implemented with the Scalable Symmetric Architecture 500 of FIG. 5. For example, the input vector, \vec{x}, may be encoded into the 2D TX array 502 as vector-encoded optical signals. The optical signals may be stored in the form of the compute domain matrix 322. The optical signals may be emitted as beams by the plurality of laser diodes 504 as coherent, partially coherent, or incoherent light. The optical signals are then projected onto the SLM 508 wherein the optical signals are modulated. For example, light from 3×3 TX gratings of the 2D TX array 502 may illuminate a 3×3 block of pixels on the SLM 508. The result of the modulation by the SLM 508 may be the optical domain matrix 326. The optical signals that have been modulated by the SLM 508 (e.g., the SLM output) are transmitted through the second microlens array 510 to the lens 512. The lens 512 images the Fourier-transformed optical signals onto the plurality of optical detectors 518 of the 2D RX array 516. For example, the 3×3 block of pixels from the SLM 508 may be imaged onto a 3×3 array of RX gratings, such that same-index pixels in each block are overlaid on each other, as shown in FIG. 3B. The EIC then subsequently decodes the blocks 324 to unwrap the resultant vector, b.

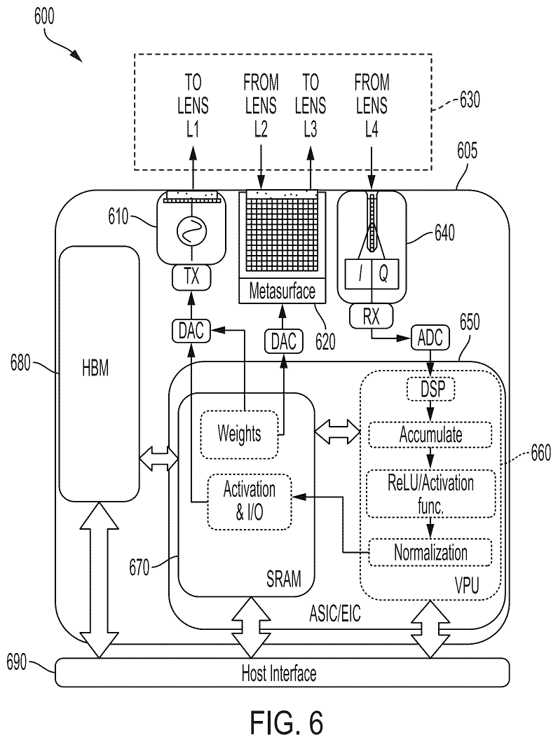

FIG. 6 illustrates a block diagram of an example implementation of an optical vector-matrix multiplication (OVMM) system 600, which includes an OVMM device 605. As illustrated, the OVMM system 600 includes a tight integration of various subsystems and components that enable high-speed, energy-efficient computational operations. In some embodiments, the OVMM system 600 implements an optical computing apparatus and/or system at least in part.

The OVMM device 605 includes a silicon photonic transmitter subsystem 610 that operates to encode a digital input vector into a transmitted optical signal. In some embodiments, the silicon photonic transmitter subsystem 610 can be implemented by and/or correspond to the TX array 402 of FIG. 4A or the TX array 502 of FIG. 5. The encoding is achieved using phase modulation and/or amplitude modulation through integrated photonic devices, such as Mach-Zehnder interferometers, electro-optic modulators, and/or ring resonators. The silicon photonic transmitter subsystem 610 can be configured to convert the digital input vector into an optical format (e.g., as a vector-encoded optical signal) to be received by the two dimensionally programmable and/or tunable optical metasurface 620 via a free space optical subsystem 630. In some embodiments, the optical metasurface 620 can be implemented by and/or correspond to the SLM 404 of FIGS. 4A-4C or the SLM 508 of FIG. 5.

The free space optical subsystem 630 receives the vector-encoded optical signal. In some embodiments, the free space optical subsystem 630 operates to distribute the vector-encoded optical signal across the dimensions of the metasurface 620 (e.g., an SLM). In some embodiments, the free space optical subsystem 630 incorporates lenses and/or mirrors to ensure precise alignment and transformation of the vector-encoded optical signal into a fanned-out vector-encoded optical signal. For example, the free space optical subsystem 630 can include at least one of the first microlens array 506, the SLM 508, the second microlens array 510, or the lens 512 of FIG. 5.

The vector-encoded optical signal is directed for incidence on the metasurface 620. The metasurface 620 is dynamically tuned to encode a digital matrix as a two-dimensional array of optical modulation parameters. Each pixel on the metasurface 620 independently modulates the phase and/or amplitude of the incident optical radiation, enabling precise element-wise operations for the vector-matrix multiplication. In some embodiments, the metasurface 620 utilizes phase-change materials, such as liquid crystals, that are dynamically adjustable to allow for rapid adjustment of the modulation parameters during operation. The use of a dynamically reconfigurable metasurface allows for sequential computations of multiple vector-matrix multiplications with varying input vectors or weighting matrices, without requiring physical hardware changes.

The metasurface 620 modulates the vector-encoded optical signal to form a modulated optical signal. The modulated optical signal represents an unsummed optical vector-matrix multiplication of the input vector and the matrix. The free space optical subsystem 630 can be configured to operate to condense the modulated optical signal along a perpendicular axis (e.g., a substantially perpendicular axis) in the second free-space optical path as shown in FIGS. 4A-4C. For example, the Scalable Symmetric Architecture 400 may use the telecentric FT lens 408 to condense the modulated optical signal from the SLM 404. The condensing operation performed by the free space optical subsystem 630 implements a summation, which completes the vector-matrix multiplication, as described in connection with FIGS. 3A-3B. As previously noted, the free space optical subsystem 630 may incorporate lenses to implement the condensing function and direct the condensed optical signal to be received by the silicon photonic receiver subsystem 640. For example, the Scalable Symmetric Architecture 400 uses the telecentric FT lens 408 (including the first lens 410 and the second lens 412) to condense and direct the SLM output 405 to the RX array 414. As another example, the Scalable Symmetric Architecture 500 uses the lens 512 to condense and direct the Fourier-transformed SLM output 517 to the 2D RX array 516.

The silicon photonic receiver subsystem 640 detects and decodes the condensed optical signal into electronic signals. The silicon photonic receiver subsystem 640 may include, for example, an array of photodetectors capable of measuring intensity, amplitude, phase, and/or polarization. As described in connection with FIGS. 3A-3B, the silicon photonic receiver subsystem 640 may be configured to decode the optical signals to unwrap a resultant vector. The silicon photonic receiver subsystem 640 operates to detect and convert the condensed optical signal into digital form. The output digital signal, corresponding to the resultant vector of the vector-matrix multiplication, is ready for further processing by other digital subsystems, transmission to a host via the host interface 690, and/or digital storage.

As described herein, an integrated control circuit 650 manages data flow between the photonic subsystems and dynamically reconfigures the metasurface 620 during operation. The integrated control circuit 650 may comprise, for example, an application specific integrated circuit (ASIC) or an EIC. The integrated control circuit 650 may include an integrated vector processing unit (VPU) 660. The VPU 660 may perform useful post-detection operations such as accumulation, Rectified Linear Unit (ReLU) activation, and/or normalization. The post-detection operations performed by the VPU 660 are particularly useful for applications in artificial intelligence and neural network inference.

In some embodiments, the integrated control circuit 650 includes tightly integrated memory modules to support high-speed, low-latency data storage and retrieval. For example, a monolithic static random-access memory (SRAM) 670 is co-located on the integrated control circuit 650. The monolithic SRAM 670 may, for example, store weights and activation data, while also facilitating input operations and/or output operations. In addition, a high-bandwidth memory (HBM) module 680 may be connected to the integrated control circuit 650 via an interposer. The HBM module 680 provides storage for large matrices and other data required for computation. The combination of integrated SRAM and high-speed connected HBM reduces latency and energy consumption during memory access operations.

In some embodiments, the HBM module 680, the SRAM 670, and the VPU 660 are accessible via a host interface 690 (e.g., via the integrated control circuit 650). The host interface 690 connects the OVMM device 605 to external computational frameworks, enabling the upload of input vectors and matrices and the retrieval of computed results. The host interface 690 supports seamless integration with larger systems, allowing the OVMM device 605 to function as a modular and versatile computational unit.

Beneficially, the illustrated architecture of the OVMM system 600 provides a balance of photonic, optical, and digital components that enable high-throughput and energy-efficient computations. The free space optical subsystem 630 allows for coplanar co-location of the silicon photonic transmitter subsystem 610, metasurface 620, and silicon photonic receiver subsystem 640 proximate to the integrated control circuit 650.

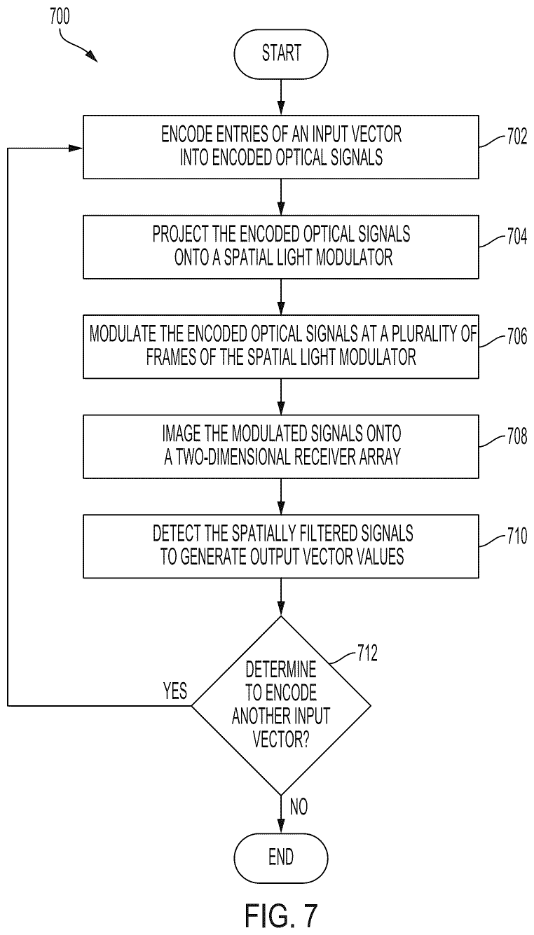

FIG. 7 is a flowchart 700 representative of an example process that may be performed by the Scalable Symmetric Architecture 400 of FIG. 4A or the Scalable Symmetric Architecture 500 of FIG. 5. Additionally and/or alternatively, the flowchart 700 may be representative of an example process that may be performed by the OVMM system 600 of FIG. 6, or portion(s) thereof, such as the OVMM device 605 and/or the free space optical subsystem 630 of FIG. 6. In some embodiments, at least some of the blocks of the flowchart 700 may be implemented by processor circuitry executing processor-executable instructions, such as the OVMM device 605 of FIG. 6 executing processor-executable instructions.

The flowchart 700 of FIG. 7 begins at block 702, at which a 2D TX array (e.g., the 2D TX array 402 or 2D TX array 502) encodes entries of an input vector into encoded optical signals. For example, the 2D TX array 402 may use a controller to drive a plurality of modulators (e.g., optical modulators) to modulate encoded optical signal. In some embodiments, the controller may be implemented by the VPU 660 of FIG. 6. Encoding the entries of the input vector may include configuring, by using a vision processing unit in an EIC (e.g., the integrated control circuit 650 embodied as an EIC described in FIG. 6), the plurality of optical modulators of the 2D TX array in accordance with a weight matrix stored in a static random-access memory.

At block 704, the 2D TX array projects the encoded optical signals onto a SLM (e.g., the SLM 404 or the SLM 508). For example, the encoded optical signals are projected by the plurality of laser diodes 504 of the 2D TX array 502 along a first free space optical path and onto the SLM 508. In some embodiments, the encoded optical signals may be projected onto the SLM 508 after passing through the first microlens array 506.

At block 706, the encoded optical signals are modulated using the SLM. For example, the encoded optical signals may be modulated at a plurality of frames of the SLM 508 of the Scalable Symmetric Architecture 500, according to corresponding row entries (e.g., entries 320 of the compute domain matrix 322) of a weight matrix (e.g., A of FIG. 3A), generating modulated signals. Each frame of the SLM 508 may correspond to a portion of the weight matrix. Modulating the encoded optical signals may include first retrieving the weight matrix from high-bandwidth memory, wherein the high-bandwidth memory is coupled to the EIC. The high-bandwidth memory may be configured to store the weight matrix.

At block 708, the modulated signals are imaged onto a 2D RX array (e.g., the RX array 414 or the 2D RX array 516) along a second free space optical path. For example, the second free space optical path may include the telecentric FT lens 408 to focus modulated signals (e.g., the SLM output 405) onto the 2D RX array 414 to perform block-wise summation of the modulated signals. The block-wise summation may include overlaying a plurality of frames of the SLM 404 onto a respective detector in the 2D RX array 414, wherein identical-index pixels from the plurality of frames of the SLM 404 are overlaid on the respective detectors of the 2D RX array 414. In some embodiments, the second microlens array is used to perform the block-wise summation.

At block 710, the summed signals are detected by the 2D RX array to generate output vector values. For example, the controller (e.g., the VPU 660 of FIG. 6) may be configured to decode the output vector values from the 2D receiver array 516 of the Scalable Symmetric Architecture 500.

At block 712, the Scalable Symmetric Architecture (e.g., the Scalable Symmetric Architecture 500) may determine whether to encode another input vector. For example, the EIC may transmit drive signals to the modulators of the SLM 508 with elements of the weight matrix or a different weight matrix. In various embodiments, this reprogramming of the SLM 508 with the different weight matrix is performed without physically reconfiguring the Scalable Symmetric Architecture 500.

If, at block 712, the Scalable Symmetric Architecture 500 determines to encode another input vector, control returns to block 702 to begin another vector-matrix multiplication cycle. Otherwise, the flowchart 700 of FIG. 7 concludes,

In some embodiments, the method depicted in flowchart 700 is configured for multilayer computations, wherein the vector-matrix multiplication is performed in a plurality of computation layers. In such embodiments, the method cascades through the plurality of computation layers. For example, the method of flowchart 700 may be performed in a computation layer of the plurality of computation layers, generating first output vector values.

The first output vector values are then fed back into a subsequent computation layer as an input vector to be encoded by the 2D TX array. For each of the plurality of computation layers, the SLM may be reprogrammed with a different weight matrix without physical reconfiguration of the SLM. Such cascading computations may be implemented in multilayered computational architectures, such as deep neural networks (DNN), convolutional neural networks (CNN), and recurrent neural networks (RNN).

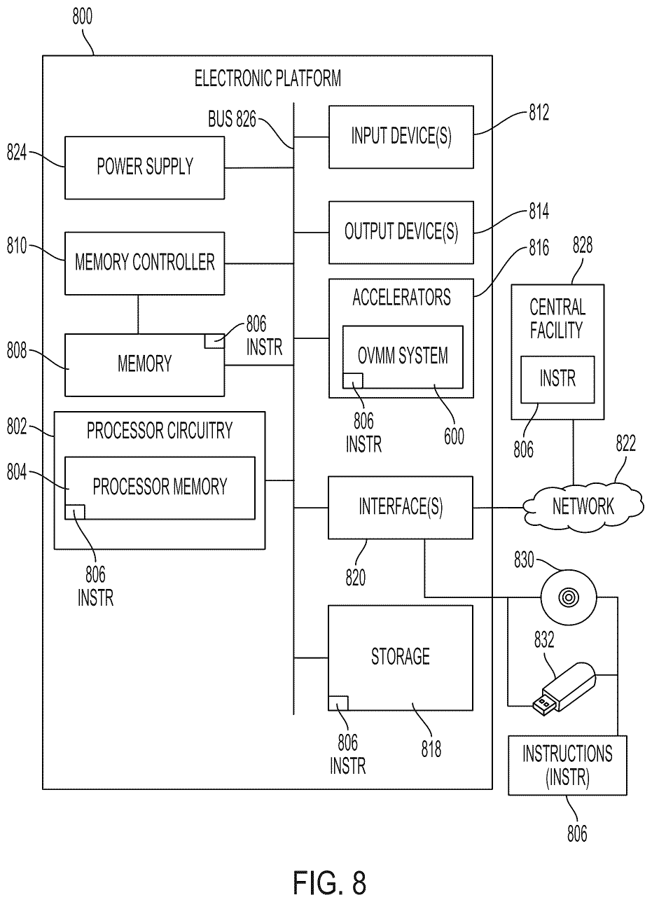

FIG. 8 is an example implementation of an electronic platform 800 structured to effectuate the process implemented by the flowchart 700 of FIG. 7 to implement (i) the Scalable Symmetric Architecture 400 of FIGS. 4A-4B, (ii) the Scalable Symmetric Architecture 500 of FIG. 5, and/or (iii) the OVMM device 605 of FIG. 6, and/or, more generally, the OVMM system 600 of FIG. 6. It should be appreciated that FIG. 8 is intended neither to be a description of necessary components for an electronic and/or computing device to operate as a free space optical architecture, an OVMM device, and/or an OVMM system, in accordance with the techniques described herein, nor a comprehensive depiction.

In some embodiments, the electronic platform 800 implements an optical computing apparatus at least in part. The electronic platform 800 of this example may be an electronic device, such as a handset device (e.g., a cellular network device, a smartphone, etc.), a desktop computer, a laptop computer, a tablet computer, a server (e.g., a computer server, a blade server, a rack-mounted server, etc.), a wearable device (e.g., an augmented reality and/or virtual reality (AR/VR) device, a heads-up display (HUD) device, a workstation, or any other type of computing and/or electronic device.

The electronic platform 800 of the illustrated example includes processor circuitry 802, which may be implemented by one or more programmable processors, one or more hardware-implemented state machines, one or more ASICs, etc., and/or any combination(s) thereof. For example, the one or more programmable processors may include one or more CPUs, one or more DSPs, one or more FPGAs, one or more GPUs, etc., and/or any combination(s) thereof. The processor circuitry 802 includes processor memory 804, which may be volatile memory, such as random-access memory (RAM) of any type.

The processor circuitry 802 may execute machine-readable instructions 806 (identified by INSTRUCTIONS), which are stored in the processor memory 804. Additionally and/or alternatively, the accelerators 816 may execute the machine-readable instructions 806 to implement the OVMM device 605 and/or, more generally, the OVMM system 600 of FIG. 6. In some embodiments, the machine-readable instructions 806 may be stored in memory of the OVMM system 600, such as the SRAM 670 and/or the HBM module 680 of FIG. 6.

The machine-readable instructions 806 may include data representative of computer-executable and/or machine-executable instructions implementing techniques that operate according to the techniques described herein. For example, the machine-readable instructions 806 may include data (e.g., code, embedded software (e.g., firmware), software, etc.) representative of the flowchart 700 of FIG. 7, or portion(s) thereof.

The electronic platform 800 includes memory 808, which may include the instructions 806. The memory 808 of this example may be controlled by a memory controller 810. For example, the memory controller 810 may control reads, writes, and/or, more generally, access(es) to the memory 808 by other component(s) of the electronic platform 800. The memory 808 of this example may be implemented by volatile memory, non-volatile memory, etc., and/or any combination(s) thereof. For example, the volatile memory may include HBM, SRAM, dynamic random-access memory (DRAM), cache memory (e.g., Level 1 (L1) cache memory, Level 2 (L2) cache memory, Level 3 (L3) cache memory, etc.), etc., and/or any combination(s) thereof. In some examples, the non-volatile memory may include Flash memory, electrically erasable programmable read-only memory (EEPROM), magnetoresistive random-access memory (MRAM), ferroelectric random-access memory (FeRAM, F-RAM, or FRAM), etc., and/or any combination(s) thereof.

The electronic platform 800 includes input device(s) 812 to enable data and/or commands to be entered into the processor circuitry 802. For example, the input device(s) 812 may include an audio sensor, a camera (e.g., a still camera, a video camera, etc.), a keyboard, a microphone, a mouse, a touchscreen, a voice recognition system, etc., and/or any combination(s) thereof.

The electronic platform 800 includes output device(s) 814 to convey, display, and/or present information to a user (e.g., a human user, a machine user, etc.). For example, the output device(s) 814 may include one or more display devices, speakers, etc. The one or more display devices may include an augmented reality (AR) and/or virtual reality (VR) display, a liquid crystal display (LCD), a light-emitting diode (LED) display, an organic light-emitting diode (OLED) display, a quantum dot (QLED) display, a thin-film transistor (TFT) LCD, a touchscreen, etc., and/or any combination(s) thereof. The output device(s) 814 can be used, among other things, to generate, launch, and/or present a user interface. For example, the user interface may be generated and/or implemented by the output device(s) 814 for visual presentation of output and speakers or other sound generating devices for audible presentation of output.

The electronic platform 800 includes accelerators 816, which are hardware devices to which the processor circuitry 802 may offload compute tasks to accelerate their processing. For example, the accelerators 816 may include artificial intelligence/machine-learning (AI/ML) processors, ASICs, FPGAs, graphics processing units (GPUs), neural network (NN) processors, systems-on-chip (SoCs), vision processing units (VPUs), etc., and/or any combination(s) thereof. In this example, the accelerators 816 implement the OVMM system 600 of FIG. 6. Although only one OVMM system 600 is shown, the accelerators 816 may implement any number of the OVMM system 600.

The electronic platform 800 includes storage 818 to record and/or control access to data, such as the machine-readable instructions 806. The storage 818 may be implemented by one or more mass storage disks or devices, such as HDDs, SSDs, etc., and/or any combination(s) thereof.

The electronic platform 800 includes interface(s) 820 to effectuate exchange of data with external devices (e.g., computing and/or electronic devices of any kind) via a network 822. The interface(s) 820 of the illustrated example may be implemented by an interface device, such as network interface circuitry (e.g., a NIC, a smart NIC, etc.), a gateway, a router, a switch, etc., and/or any combination(s) thereof. The interface(s) 820 may implement any type of communication interface, such as BLUETOOTH®, a cellular telephone system (e.g., a 4G LTE interface, a 5G interface, a future generation 6G interface, etc.), an Ethernet interface, a near-field communication (NFC) interface, an optical disc interface (e.g., a Blu-ray disc drive, a Compact Disk (CD) drive, a Digital Versatile Disk (DVD) drive, etc.), an optical fiber interface, a satellite interface (e.g., a BLOS satellite interface, a LOS satellite interface, etc.), a Universal Serial Bus (USB) interface (e.g., USB Type-A, USB Type-B, USB TYPE-CTM or USB-CTM, etc.), etc., and/or any combination(s) thereof.

The electronic platform 800 includes a power supply 824 to store energy and provide power to components of the electronic platform 800. The power supply 824 may be implemented by a power converter, such as an alternating current-to-direct-current (AC/DC) power converter, a direct current-to-direct current (DC/DC) power converter, etc., and/or any combination(s) thereof. For example, the power supply 824 may be powered by an external power source, such as an alternating current (AC) power source (e.g., an electrical grid), a direct current (DC) power source (e.g., a battery, a battery backup system, etc.), etc., and the power supply 824 may convert the AC input or the DC input into a suitable voltage for use by the electronic platform 800. In some examples, the power supply 824 may be a limited duration power source, such as a battery (e.g., a rechargeable battery such as a lithium-ion battery).

Component(s) of the electronic platform 800 may be in communication with one(s) of each other via a bus 826. For example, the bus 826 may be any type of computing and/or electrical bus, such as an I2C bus, a PCI bus, a PCIe bus, a SPI bus, a UCIe bus, and/or the like.

The network 822 may be implemented by any wired and/or wireless network(s) such as one or more cellular networks (e.g., 4G LTE cellular networks, 5G cellular networks, future generation 6G cellular networks, etc.), one or more data buses, one or more local area networks (LANs), one or more optical fiber networks, one or more private networks, one or more public networks, one or more wireless local area networks (WLANs), etc., and/or any combination(s) thereof. For example, the network 822 may be the Internet, but any other type of private and/or public network is contemplated.

The network 822 of the illustrated example facilitates communication between the interface(s) 820 and a central facility 828. The central facility 828 in this example may be an entity associated with one or more servers, such as one or more physical hardware servers and/or virtualizations of the one or more physical hardware servers. For example, the central facility 828 may be implemented by a public cloud provider, a private cloud provider, etc., and/or any combination(s) thereof. In this example, the central facility 828 may compile, generate, update, etc., the machine-readable instructions 806 and store the machine-readable instructions 806 for access (e.g., download) via the network 822. For example, the electronic platform 800 may transmit a request, via the interface(s) 820, to the central facility 828 for the machine-readable instructions 806 and receive the machine-readable instructions 806 from the central facility 828 via the network 822 in response to the request.

Additionally or alternatively, the interface(s) 820 may receive the machine-readable instructions 806 via non-transitory machine-readable storage media, such as an optical disc 830 (e.g., a Blu-ray disc, a CD, a DVD, etc.) or any other type of removable non-transitory machine-readable storage media such as a USB drive 832. For example, the optical disc 830 and/or the USB drive 832 may store the machine-readable instructions 806 thereon and provide the machine-readable instructions 806 to the electronic platform 800 via the interface(s) 820.

Techniques operating according to the principles described herein may be implemented in any suitable manner. The processing and decision blocks of the flowchart(s) above represent steps and acts that may be included in algorithms that carry out these various processes. Algorithms derived from these process(es) may be implemented as software integrated with and directing the operation of one or more single-or multi-purpose processors, may be implemented as functionally equivalent circuits such as a DSP circuit or an ASIC, or may be implemented in any other suitable manner. It should be appreciated that the flowchart(s) included herein do(es) not depict the syntax or operation of any particular circuit or of any particular programming language or type of programming language. Rather, the flowchart(s) illustrate the functional information one skilled in the art may use to fabricate circuits or to implement computer software algorithms to perform the processing of a particular apparatus carrying out the types of techniques described herein. For example, the flowchart(s), or portion(s) thereof, may be implemented by hardware alone (e.g., one or more analog or digital circuits, one or more hardware-implemented state machines, etc., and/or any combination(s) thereof) that is configured or structured to carry out the various processes of the flowcharts. In another example, the flowchart(s), or portion(s) thereof, may be implemented by machine-executable instructions (e.g., machine-readable instructions, computer-readable instructions, computer-executable instructions, etc.) that, when executed by one or more single-or multi-purpose processors, carry out the various process(es) of the flowchart(s). It should also be appreciated that, unless otherwise indicated herein, the particular sequence of steps and/or acts described in each flowchart is merely illustrative of the algorithms that may be implemented and can be varied in implementations and embodiments of the principles described herein.

Accordingly, in some embodiments, the techniques described herein may be embodied in machine-executable instructions implemented as software, including as application software, system software, firmware, middleware, embedded code, or any other suitable type of computer code. Such machine-executable instructions may be generated, written, etc., using any of a number of suitable programming languages and/or programming or scripting tools, and also may be compiled as executable machine language code or intermediate code that is executed on a framework, virtual machine, or container.

In some, but not all, implementations in which the techniques may be embodied as machine-executable instructions, these instructions may be executed on one or more suitable computing device(s) and/or electronic device(s) operating in any suitable computer and/or electronic system, or one or more computing devices (or one or more processors of one or more computing devices) and/or one or more electronic devices (or one or more processors of one or more electronic devices) may be programmed to execute the machine-executable instructions. A computing device, electronic device, or processor (e.g., processor circuitry) may be programmed to execute instructions when the instructions are stored in a manner accessible to the computing device, electronic device, or processor, such as in a data store (e.g., an on-chip cache or instruction register, a computer-readable storage medium and/or a machine-readable storage medium accessible via a bus, a computer-readable storage medium and/or a machine-readable storage medium accessible via one or more networks and accessible by the device/processor, etc.).

Machine-executable instructions (e.g., processor-executable instructions) implementing the techniques described herein may, in some embodiments, be encoded on one or more computer-readable media, machine-readable media, etc., to provide functionality to the media.

Computer-readable media, machine-readable media, etc., include magnetic media such as a hard disk drive, optical media such as a CD or a DVD, a persistent or non-persistent solid-state memory (e.g., Flash memory, Magnetic RAM, etc.), or any other suitable storage media. Such a computer-readable medium, a machine-readable medium, etc., may be implemented in any suitable manner.

Embodiments have been described where the techniques are implemented in circuitry and/or machine-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

As used herein, the terms “computer-readable media” (also called “computer-readable storage media”), “computer-readable medium” (also called “computer-readable storage medium”), “machine-readable media” (also called “machine-readable storage media”), and “machine-readable medium” (also called “machine-readable storage medium”) refer to tangible storage media. Tangible storage media are non-transitory and have at least one physical, structural component. In a “computer-readable medium” and “machine-readable medium” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium, a machine-readable medium, etc., may be altered during a recording process.

Further, some techniques described above comprise acts of storing information (e.g., data and/or instructions) in certain ways for use by these techniques. In some implementations of these techniques-such as implementations where the techniques are implemented as machine-executable instructions-the information may be encoded on a computer-readable storage medium, a machine-readable storage medium, etc. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.” As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Accordingly, having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

1. A system for performing optical vector-matrix multiplication, comprising:
a two-dimensional (2D) transmitter array comprising a plurality of optical modulators, the 2D transmitter array configured to:
encode entries of an input vector into a vector-encoded optical signal; and
emit the vector-encoded optical signal;
a spatial light modulator (SLM) comprising a plurality of programmable pixels arranged into frames, each frame corresponding to a row of a weight matrix, wherein the SLM is configured to modulate the vector-encoded optical signal in accordance with matrix entries of the weight matrix to generate SLM output, the SLM output comprising a plurality of optical signals that is output from the frames;
a first free space optical path positioned between the 2D transmitter array and the SLM;
a second free space optical path configured to perform a block-wise summation of the plurality of optical signals of the SLM output to generate a summation output; and
a 2D receiver array comprising a plurality of optical detectors configured to generate an output vector based on the summation output,
wherein the second free space optical path is between the SLM and the 2D receiver array.

2. (canceled)

3. The system of claim 1, wherein a free space optical path, comprising the first free space optical path and the second free space optical path, comprises rotationally symmetric optics.

4. The system of claim 1, wherein the SLM comprises a programmable active metasurface, the programmable active metasurface comprising a plurality of individually addressable pixels, each of the plurality of individually addressable pixels configured to modulate at least one of an intensity, amplitude, or phase of incident light.

5. The system of claim 4, wherein the programmable active metasurface is configured to modulate the at least one of the intensity, amplitude, or phase of incident light by using a liquid crystal mixture comprising one or more liquid crystals.

6.-12. (canceled)

13. The system of claim 1, wherein the 2D transmitter array comprises a plurality of waveguides, and the system further comprising:
an electronic integrated circuit; and
a photonic integrated circuit electrically coupled to the electronic integrated circuit and optically coupled to a light source, the photonic integrated circuit comprising the 2D transmitter array, and the plurality of optical modulators and the plurality of waveguides are driven by the electronic integrated circuit via at least one bump bond or at least one through-silicon via.

14. (canceled)

15. The system of claim 13, wherein the light source comprises at least one of a plurality of fiber optic cables, light-emitting diodes (LEDs), microLEDs, or vertical-cavity surface-emitting lasers (VCSELs).

16. The system of claim 13, wherein the 2D transmitter array comprises a first 2D array of grating couplers, each grating coupler optically coupled to a corresponding waveguide modulator on the photonic integrated circuit, and wherein the 2D receiver array comprises a second 2D array of grating couplers each optically coupled to one or more corresponding optical detectors via optical waveguides on the photonic integrated circuit.

17. The system of claim 1, wherein the plurality of optical detectors of the 2D receiver array comprises a plurality of grating couplers, and wherein adjacent grating couplers are separated by a pitch, the pitch configured to provide optical isolation between channels such that stray light incident on the 2D receiver array outside an acceptance cone of a given grating coupler does not couple into an optical waveguide associated with that grating coupler.

18. The system of claim 1, wherein the 2D receiver array further comprises a low-reflectivity absorbing material disposed between adjacent grating couplers, the low-reflectivity absorbing material configured to attenuate stray optical signals not directed at any grating coupler.

19. (canceled)

20. (canceled)

21. The system of claim 13, wherein the 2D transmitter array comprises a first 2D array of emitting couplers, each emitting coupler optically coupled to a corresponding waveguide modulator on the photonic integrated circuit, and wherein the 2D receiver array comprises a second 2D array of emitting couplers each optically coupled to one or more corresponding optical detectors via optical waveguides on the photonic integrated circuit.

22. (canceled)

23. The system of claim 1, further comprising a photonic integrated circuit comprising the 2D transmitter array and drive circuitry monolithically integrated therein, wherein the drive circuitry is configured to drive the plurality of optical modulators.

24. The system of claim 1, further comprising a first microlens array, positioned between the 2D transmitter array and the SLM,
wherein the first microlens array comprises a first plurality of microlenses and each microlens of the first plurality of microlenses is configured to receive a beam emitted from the 2D transmitter array,
wherein the first microlens array is configured to output the respective beams to the SLM.

25. (canceled)

26. The system of claim 1, wherein the 2D transmitter array is configured to receive light from a coherent light source,
wherein the 2D transmitter array is configured to encode the entries of the input vector into the vector-encoded optical signal by using at least one of amplitude modulation, phase modulation, or intensity modulation, and
wherein the SLM is configured to modulate the vector-encoded optical signal in accordance with the matrix entries of the weight matrix to generate the SLM output by using at least one of an amplitude or a phase modulation of the vector-encoded optical signal.

27. (canceled)

28. The system of claim 1, wherein the 2D transmitter array is configured to receive light from a partially coherent light source, and wherein the 2D transmitter array is configured to encode the entries of the input vector into the vector-encoded optical signal by using at least one of amplitude modulation, phase modulation, or intensity modulation.

29. The system of claim 1, wherein the 2D transmitter array is configured to receive light from an incoherent light source,
wherein the 2D transmitter array is configured to encode the entries of the input vector into the vector-encoded optical signal using intensity modulation.

30. The system of claim 29, wherein each optical modulator of the 2D transmitter array is coupled to a respective coherent light source.

31.-33. (canceled)

34. The system of claim 1, further comprising at least one first lens, wherein the at least one first lens is configured to perform a spatial Fourier transform on the SLM output to generate a Fourier-transformed SLM output, wherein the second free space optical path performs a block-wise summation of the Fourier-transformed SLM output to generate the summation output.

35. The system of claim 34, further comprising a second microlens array positioned between the SLM and the at least one first lens,
wherein the second microlens array comprises a second plurality of microlenses and each microlens of the second plurality of microlenses is configured to receive a beam exiting the SLM,
wherein the second microlens array is configured to fan out the respective beams to the at least one first lens.

36.-38. (canceled)

39. The system of claim 1, wherein a number of the plurality of optical modulators in the 2D transmitter array, a number of frames of the SLM, and a number of the plurality of optical detectors in the 2D receiver array are all equal.

40. The system of claim 34, further comprising at least one second lens, wherein the at least one second lens is configured to image output from each frame of the SLM onto a corresponding single optical detector of the 2D receiver array.

41. The system of claim 1, wherein the plurality of optical modulators comprise electro-absorption modulators, Mach-Zehnder interferometers, optical ring resonators, silicon-insulator-silicon-capacitive (SISCAP) modulators, or thermal modulators.

42. A method for performing optical vector-matrix multiplication, comprising:
encoding, by using a two-dimensional (2D) transmitter array, entries of an input vector into encoded optical signals;
projecting, by using the 2D transmitter array and a first free space optical path, the encoded optical signals onto a spatial light modulator (SLM);
modulating, by using the SLM, the encoded optical signals at a plurality of frames of the SLM according to corresponding row entries of a weight matrix to generate modulated signals, each frame of the SLM corresponding to a portion of the weight matrix;
imaging, by using a second free space optical path, the modulated signals onto a 2D receiver array, wherein the second free space optical path is configured to perform block-wise summation of the modulated signals to generate a summation output; and
detecting, by using a 2D receiver array, the summation output to generate output vector values.

43. The method of claim 42, wherein the block-wise summation comprises:
overlaying a plurality of frames of the SLM onto a respective detector in the 2D receiver array,
wherein identical-index pixels from the plurality of frames of the SLM are overlaid on the respective detectors.

44. (canceled)

45. The method of claim 42, wherein the method is performed sequentially, the method further comprising:
reprogramming, without physical reconfiguration, the SLM with a different weight matrix to perform a subsequent optical vector-matrix multiplication cycle.

46. The method of claim 42, wherein the method is configured for multilayer computations, such that the method cascades, wherein:
first output vector values generated in a computation layer are fed back to a subsequent computation layer as an input vector to be encoded by the 2D transmitter array, and
the SLM is reprogrammed with different weight matrix to perform a subsequent optical vector-matrix multiplication cycle without physical reconfiguration.

47. The method of claim 42, wherein the 2D transmitter array comprises a plurality of modulators, the method further comprising:
driving, by using a controller, the plurality of modulators; and
decoding, by using the controller, the output vector values from the 2D receiver array.

48.-49. (canceled)

50. An optical computing apparatus comprising:
a photonic integrated circuit comprising a plurality of waveguides and modulators configured to encode an input vector;
free space optics comprising:
a two-dimensional (2D) transmitter array comprising a plurality of optical modulators, the 2D transmitter array configured to:
encode, by using at least one of intensity modulation, amplitude modulation, or phase modulation, entries of an input vector into a vector-encoded optical signal; and
emit the vector-encoded optical signal;
a spatial light modulator (SLM) comprising a plurality of programmable pixels arranged into frames, each frame corresponding to a row of a weight matrix, wherein the SLM is configured to modulate the vector-encoded optical signal in accordance with matrix entries of the weight matrix to generate an SLM output, the SLM output comprising a plurality of optical signals that is output from the frames;
a first free space optical path positioned between the 2D transmitter array and the SLM; and
a second free space optical path configured to perform a block-wise summation of the plurality of optical signals of the SLM output to generate a summation output;
a 2D receiver array comprising a plurality of optical detectors configured to generate an output vector based on the summation output; and
an electronic integrated circuit configured to drive the modulators on the photonic integrated circuit and to decode output values from the 2D receiver array,
wherein the second free space optical path is between the SLM and the 2D receiver array.

51. (canceled)

52. The optical computing apparatus of claim 50, wherein:
the photonic integrated circuit comprises the 2D transmitter array and the 2D receiver array, wherein the 2D transmitter array and the 2D receiver array are arranged in a coplanar configuration; and
the SLM is positioned in a free space optical path between the 2D transmitter array and the 2D receiver array.

53.-55. (canceled)

56. The optical computing apparatus of claim 50, wherein the electronic integrated circuit comprises processor circuitry configured to drive the modulators on the photonic integrated circuit and to decode output values from the 2D receiver array.

57. The optical computing apparatus of claim 50, wherein the electronic integrated circuit comprises a vision processing unit configured to execute at least one post-detection operation on the output values from the 2D receiver array.

58. The optical computing apparatus of claim 57, wherein the at least one post-detection operation comprises an accumulation, Rectified Linear Unit (ReLU) activation, and/or normalization operation, and the vision processing unit is configured to execute at least one of the accumulation, the ReLU activation, or normalization operation.

59. The optical computing apparatus of claim 50, further comprising high-bandwidth memory configured to store a weight matrix, and wherein the electronic integrated circuit comprises:
static random-access memory; and
a vision processing unit configured to:
retrieve the weight matrix from the high-bandwidth memory and store the retrieved weight matrix in the static random-access memory; and
configure the plurality of optical modulators in accordance with at least a portion of the weight matrix to encode the input vector.

60.-62. (canceled)
